(19) United States
(12) Patent Application Publication
(10) Pub. No.: US 2005/0242179 A1
(43) Pub. Date: Nov. 3, 2005

(54) Loyalty system incorporating embedded incentives

(75) Inventor: John S. Warwick, West Port, CT (US)

Correspondence Address: SCHWEGMAN, LUNDBERG, WOESSNER & KLUTH, P.A., P.O. BOX 2938, MINNEAPOLIS, MN, 55402-0938, US

(73) Assignees: Carlson Companies, Inc.; Carlson Marketing Group, Inc.

(21) Appl. No.: 11/109,501

(22) Filed: Apr. 19, 2005

Related U.S. Application Data
(63) Continuation of application No. 10/704,207, filed on Nov. 7, 2003, now abandoned.
Application No. 10/704,207 is a continuation of application No. 09/999,481, filed on Oct. 31, 2001, now abandoned.
(60) Provisional application No. 60/244,703, filed on Oct. 31, 2000.

(51) Int. Cl. G06F 17/60; G06K 15/00

(52) U.S. Cl. 235/383; 705/14

(57) ABSTRACT

A method for stimulating customer loyalty comprising: providing an incentive into an electronic device, the electronic device being capable of facilitating the purchase of a product or service, using the electronic device to facilitate the purchase of a product over an electronic communications network, said step of using the electronic device comprising: coupling the electronic device to the network, purchasing the product or service over the network using the electronic device, paying for the product or service with the incentive, debiting the incentive in the electronic device once the purchase has been completed.

### CROSS REFERENCE TO RELATED APPLICATIONS

This application claims the priority and benefit of U.S. Provisional Patent Application No. 60/244,703 filed Oct. 31, 2000 entitled “Loyalty System Incorporating Embedded Incentives” the disclosure of which is hereby incorporated by reference.

### BACKGROUND OF THE INVENTION

The present invention relates to loyalty systems, and in particular, to loyalty/incentive programs for stimulating repeat purchases and consumer loyalty.

There are various systems known for stimulating consumer loyalty. For example, a well known consumer loyalty program is the frequent flyer mileage program by which air travelers get mileage for trips taken on air carriers which they collect in their account and later redeem for free airfare. Various incentive programs on the internet are also known. For example, beenz.com has a program under which it sells an internet currency known as “beenz” to participating vendors. When a user goes to the vendor's website and performs certain functions at the website including, for example, buying merchandise or merely visiting the website in some instances, the customer is rewarded with beenz by the vendor. The customer collects beenz in an account which is administered by beenz.com and is free to redeem those beenz at any participating vendor's website. The participating vendor's website that redeems the beenz may not be the same vendor who provided the beenz in the first place. A user may, for example, redeem the beenz for something of value, e.g., by purchasing an item on the website with the beenz.

It is also known, based upon the Finsterwald patent, U.S. Pat. No. 6,039,244 that the internet can be used for rewarding off-line loyalty. For example, under that patent, a user may purchase (at a ‘bricks and mortar” store or on the internet) an item which has a code not visible on the item purchased until the user purchases it and can access the code. Once the user has purchased the item, the user can obtain the code and enter the code onto an internet website. Once the code is validated by the website, the user collects value in an account which the user can later redeem for something of value when it has collected sufficient value in the account. The above patent is a hybrid type system because it allows loyalty off-line (and also on-line) to be rewarded on line. The frequent flyer programs were intially off-line types of loyalty programs because they rewarded off-line loyalty also off line.

### SUMMARY OF THE INVENTION

The present invention is directed to a loyalty program with an embedded incentive contained in an electronic device to encourage consumer loyalty. The invention can be used to encourage both off-line and on-line loyalty, i.e., repeated purchases. In particular, according to one embodiment of the invention, an electronic device such as an e-book or other device capable of downloading materials from the internet or other electronic netework is embedded with a coded incentive upon purchase of the electronic device. For example, the electronic device may be an e-book which is capable of downloading books and other text materials from the internet or other electronic network.

Other features and advantages of the present invention will become apparent from the following description of the invention which refers to the accompanying drawings.

### BRIEF DESCRIPTION OF THE DRAWING(S)

The invention will now be described in detail in the following detailed description, with reference to the drawings, in which

FIG. 1 shows an overall block diagram of the system of the invention.

### DETAILED DESCRIPTION OF EMBODIMENTS OF THE INVENTION

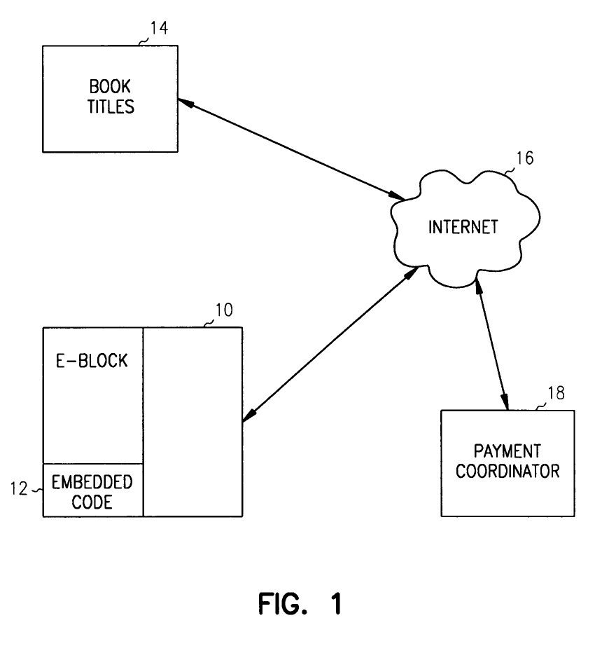

With reference to FIG. 1 which shows an embodiment of the invention, a purchaser purchases an e-book 10 (or other electronic device such as a PDA, web phone or game device) from a vendor. The purchase can be made either off-line or on-line. Alternatively, the user subscribes to the loyalty program using an already possessed electronic device. To encourage the user to make a first download of written materials, for example to obtain a book from the internet or other network, the e-book 10 is provided with an embedded incentive code 12, for example, stored in a memory of the e-book 10. The embedded incentive code has a value, for example, it may have a value in dollars or other currency or it may have a value in internet currency such as beenz. Preferably, the value is sufficient to enable at least one initial download of a title from a server 14 via the internet 16. A payment coordinator 18 is also connected to the internet or other network via an appropriate connection, and it records the transaction, i.e., the downloading of a book title from the book server 14 to the e-book 10 via the network and maintains a record of the transaction, i.e., that the value of the embedded code in the e-book 10 has been used to purchase a book title from the book server 14. Payment to the book seller can thereby be made by the payment coordinator. In the case of an internet currency such as beenz, the payment coordinator 18 will cause the embedded code to be invalidated after purchase or reduced in value if the purchase price was less than the value of the embedded code. Further, the payment coordinator 18 can also debit the account of the holder of the e-book 10 if an account has already been established. Once the embedded code has been invalidated or its value is less than that necessary to purchase another item, for example another book, the user may obtain additional internet currency, for example, beenz, by performing other actions on the internet and thereby obtain enough internet currency to pay for further purchases. Alternatively, the user may wish to pay for further purchases directly using a credit card or a debit card.

In any event, the embedded code 12 having a value in the e-book 10 provides an incentive for the user to make a first purchase download by using the value of the embedded code to pay for that purchase.

At the time that a consumer first uses the e-book device 10, the consumer is preferably asked to fill out a simple enrollment form, including credit card numbers to enable purchases of further content and future products. That process can include an explanation of internet currency, for example beenz, and an introduction to various sites where they can earn these beenz. The e-book owner, as discussed above, is also credited with sufficient beenz to enable the first content purchase. Most people attempting to purchase on-line today stop the process before completion due to fear and frustration. Owners of the e-book, having the embedded incentive 12, having once successfully downloaded content using the risk free incentive, will become familiar with the process and be more likely to purchase other products in the future.

Although the system has illustratively been shown with the code embedded in an e-book, the code can be embedded in any electronic device capable of accessing the internet including PDA, web phones, interactive TV, game devices, PC's etc). Further the incentive need not be embedded at purchase of the device but may be downloaded later, as part of a promotional campaign, for example.

Although the present invention has been described in relation to particular embodiments thereof, many other variations and modifications and other uses will become apparent to those skilled in the art. Therefore, the present invention should be limited not by the specific disclosure herein, but only by the appended claims.

1. A method for stimulating customer loyalty comprising:
providing an incentive into an electronic device, the electronic device being capable of facilitating the purchase of a product or service;
using the electronic device to facilitate the purchase of a product over an electronic communications network;
said step of using the electronic device comprising:
coupling the electronic device to the network;
purchasing the product or service over the network using the electronic device;
paying for the product or service with the incentive;
debiting the incentive in the electronic device once the purchase has been completed.

2. The method of claim 1, further comprising downloading additional incentive into the electronic device to facilitate further transactions.

3. The method of claim 1, further comprising purchasing additional products or services over the network using conventional payment means such as a credit card or debit card.

4. The method of claim 1, wherein the incentive comprises an internet currency.

5. The method of claim 1, further comprising a payment coordinator connected to the network for administering an account of a purchaser to cause payment to be made to a seller of the product or service.

6. The method of claim 5, wherein the payment coordinator comprises an administrator of an internet currency, said administrator of the internet currency maintaining said purchaser's account.

7. The method of claim 1, wherein the incentive comprises a code which is validated by the seller of the product or service.

8. The method of claim 5, wherein the code is validated by the payment coordinator.

9. The method of claim 1, wherein the network comprises the internet.

10. The method of claim 1, wherein the electronic device comprises an e-book.

11. The method of claim 1, wherein the electronic device comprises one of a personal digital assistant, web phone, game device, interactive TV or PC.

12. The method of claim 1, wherein the incentive is embedded in the electronic device upon acquisition of the electronic device by a purchaser.

13. The method of claim 1, wherein the incentive is downloaded to the electronic device over the network.

14. A system for stimulating customer loyalty comprising:
an electronic device, the electronic device including an incentive component therein to facilitate the purchase of a product or service over an electronic communications network;
said electronic device comprising:
a port to couple the electronic device to the network, whereby a user can purchase the product or service over the network using the electronic device by paying, at least in part, for the product or service with the incentive;
the incentive in the electronic device being debited once the purchase has been completed.

15. The system of claim 14, further wherein additional incentive can be downloaded into the electronic device to facilitate further transactions.

16. The system of claim 14, further wherein additional products or services can be purchased over the network using conventional payment means such as a credit card or debit card.

17. The system of claim 14, wherein the incentive comprises an internet currency stored in a memory of the electronic device.

18. The system of claim 14, further comprising a payment coordinator connected to the network for administering an account of a purchaser to cause payment to be made to a seller of the product or service.

19. The system of claim 18, wherein the payment coordinator comprises an administrator of an internet currency, said administrator of the internet currency maintaining said purchaser's account.

20. The system of claim 14, wherein the incentive comprises a code which is validated by the seller of the product or service.

21. The system of claim 18, wherein the code is validated by the payment coordinator.

22. The system of claim 14, wherein the network comprises the internet.

23. The system of claim 14, wherein the electronic device comprises an e-book.

24. The system of claim 14, wherein the electronic device comprises one of a personal digital assistant, web phone, game device, interactive TV or PC.

25. The system of claim 14, wherein the incentive is embedded in the electronic device upon acquisition of the electronic device by a purchaser.

26. The system of claim 14, wherein the incentive is downloaded to the electronic device over the network.
